(19) United States
(12) Patent Application Publication
(10) Pub. No.: US 2005/0140055 A1
(43) Pub. Date: Jun. 30, 2005

(54) Method for making a part by injection molding and decorating visually-exposed face and side surfaces of the part in their entireties during the injection molding of the part

(76) Inventor: Sami Sagol, Ilerzelia (IL)

Correspondence Address: CHARLES E. BAXLEY, ESQ., 90 JOHN STREET, THIRD FLOOR, NEW YORK, NY, 10038, US

(21) Appl. No.: 10/746,437

(22) Filed: Dec. 24, 2003

(51) Int. Cl. B29C 45/14

(52) U.S. Cl. 264/259

(57) ABSTRACT

A method for making a part by injection molding and decorating a visually-exposed face surface and a visually-exposed side surface of the part in their entireties during the injection molding of the part. The method includes the steps of providing a mold, inserting a decorative film into the mold, closing the mold, injecting a molten material into the mold causing the decorative film to conform to the mold by virtue of the molten material, when filling the mold, exerting a force on the decorative film forcing the decorative film to abut intimately against the mold, hardening the molten material so as to form a hardened core, and forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

### BACKGROUND OF THE INVENTION

1. Field of the Invention

The present invention relates to a method for making a part. More particularly, the present invention relates to a method for making a part by injection molding and decorating visually-exposed face and side surfaces of the part in their entireties during the injection molding of the part.

2. Description of the Prior Art

Images are often applied to surfaces of a part, such as, but not limited to, a table top, a cabinet door, or the like, to enhance the appearance of the part, but require a multi-step process. This multi-step process includes producing the part and then subsequent thereto applying the images to the already produced part.

Thus, there exists a need for a method to reduce processing steps and costs for enhancing the appearance of an injection molded part by having film applied during the injection molding process that covers visually-exposed face and side surfaces of the part and the edge of the part formed where the visually-exposed face and side surfaces of the part meet, in their entireties.

Numerous innovations for injected molded related devices have been provided in the prior art. Even though these innovations may be suitable for the specific individual purposes to which they address, they each differ in structure and/or operation and/or purpose from the present invention.

FOR EXAMPLE, U.S. Patent Application Publication Number U.S. 2003/0122278 A1 to Kosanvoich teaches a method for applying multiple decorative sheets of film to an injection-mold component as a part of the injection mold process. Two sheets of film having desired images are permanently affixed to the surfaces of the injection mold component as a part of the injection molding process. An enhanced three-dimensional appearance is achieved by affixing the images to a transparent injection mold component.

ANOTHER EXAMPLE, U.S. Pat. No. 4,052,497 to Monnet teaches a method for the manufacture by injection molding of articles composed of a plurality of layers of at least three distinct materials coated one over the other. The method includes the steps of successive injection of a measured quantity of a first material adapted to form the skin of the article, a measured quantity of a second material to form the intermediate layer, and a measured quantity of a third material to form the body of the article. The materials are introduced into the mold coaxially so as to give a uniform distribution. The method is especially applicable to the production of articles in which the external and internal materials are joined together by an intermediate material.

STILL ANOTHER EXAMPLE, U.S. Pat. No. 4,686,076 to Dromigny et al. teaches a method, machine, and mold for fabricating, by injection of synthetic material, containers having a film forming an external coating. The machine includes a mold, an injection nozzle, a film feed device, and apparatus for holding the film against the male element of the mold. The injection nozzle is carried by the male element of the mold and the holding apparatus includes a slider in the cavity of the female element movable, under the action of the male element, against a return force.

YET ANOTHER EXAMPLE, U.S. Pat. No. 5,240,751 to Cakmakei teaches a decorative automotive vehicle trim strip and method and apparatus for forming by reshaping an end of a previously extruded length of thermoplastic material. The surface of the length of the thermoplastic material intended for viewing is maintained at a cold temperature, well below the softening point of the thermoplastic material, during the reshaping operation. The length of the thermoplastic material is heated during reshaping by a mold section heated to 400 degrees F. to 410 degrees F. pressed against the surface intended to be affixed to the vehicle.

STILL YET ANOTHER EXAMPLE, U.S. Pat. No. 5,415,536 to Ohno teaches a method for forming a pattern onto an article during injection molding thereof. A pattern-bearing film is heated and softened by a heating board. The softened pattern-bearing film is transferred to the cavity surface of a female mold. Thereafter, the female mold and a male mold are closed. Then, a molten resin is injected into the cavity. When the pattern-bearing film is brought into contact with and heated by the heating board, marks or impressions of air blow holes on the surface of the heating board remain on the pattern-bearing film. To prevent the formation of these marks or impressions, a square-shaped holding frame is fixed on the surface of the heating board. The peripheral portion of the pattern-bearing film is held on the surface of the holding frame. Thus, while the pattern portion of the pattern-bearing film is spaced apart from the surface of the heating board, the film is heated. To keep the pattern-bearing film uniformly spaced from the surface of the heating board, air is supplied to the inside of the holding frame.

YET STILL ANOTHER EXAMPLE, U.S. Pat. No. 6,090,336 to Hirmer et al. teaches a method and apparatus for manufacturing an injection-molded article having an outer film on an exposed surface. The method includes securing the film about its periphery within a mold cavity prior to injection of molten material into the cavity. One way of securing the film is by applying vacuum pressure through peripheral holes in a frame surrounding the mold cavity. Molten material is injected into the cavity behind the film, and the film slips from its initial position to be forced against a wall of the cavity by molten material being injected into the cavity. The apparatus includes a frame for a molding apparatus adapted to initially secure the film in place prior to movement of the core block into place and to permit the film to slip from its initial position to be forced against the cavity wall as molten material fills the cavity.

STILL YET ANOTHER EXAMPLE, U.S. Pat. No. 6,474,976 to Oami et al. teaches a film holding apparatus for an injection mold which is capable of surely holding a protective film on a specific position of a mold surface of the injection mold. The film holding apparatus for holding an inner film on the mold surface of the injection molds consisting of two coupled molds having substantially-vertical coupled surfaces thereof which includes two positioning pins that can hang an upper edge side of the inner film on an upper edge portion of the mold surface of the mold, and upper and lower vacuum opening portions for film adsorption disposed so as to interpose the positioning pins therebetween from the upper and lower sides. The upper vacuum opening portion is formed in a line which extends along an upper edge of the mold surface.

It is apparent that numerous innovations for injected molded related devices have been provided in the prior art that are adapted to be used. Furthermore, even though these innovations may be suitable for the specific individual purposes to which they address, they would not be suitable for the purposes of the present invention as heretofore described.

### SUMMARY OF THE INVENTION

ACCORDINGLY, AN OBJECT of the present invention is to provide a method for making a part by injection molding and decorating visually-exposed face and side surfaces of the part in their entireties during the injection molding of the part that avoids the disadvantages of the prior art.

ANOTHER OBJECT of the present invention is to provide a method for making a part by injection molding and decorating visually-exposed face and side surfaces of the part in their entireties during the injection molding of the part that is simple to use.

STILL ANOTHER OBJECT of the present invention is to provide a method for making a part by injection molding and decorating visually-exposed face and side surfaces of the part in their entireties during the injection molding of the part that provides far superior looks to that of just a molded part which does not have a film application or does have a film application that does not reach the full edge of the part.

YET ANOTHER OBJECT of the present invention is to provide a method for making a part by injection molding and decorating visually-exposed face and side surfaces of the part in their entireties during the injection molding of the part that provides a faux finish to a Olefin resin part.

STILL YET ANOTHER OBJECT of the present invention is to provide a method for making a part by injection molding and decorating visually-exposed face and side surfaces of the part in their entireties during the injection molding of the part that allows the use of recycled resins without the disadvantage of color variations, as the film covers the visible surfaces.

YET STILL ANOTHER OBJECT of the present invention is to provide a method for making a part by injection molding and decorating visually-exposed face and side surfaces of the part in their entireties during the injection molding of the part that achieves superior design and cost efficiencies.

BRIEFLY STATED, STILL YET ANOTHER OBJECT of the present invention is to provide a method for making a part by injection molding and decorating visually-exposed face and side surfaces of the part in their entireties during the injection molding of the part. The method includes the steps of providing a mold, inserting a decorative film into the mold, closing the mold, injecting a molten material into the mold causing the decorative film to conform to the mold by virtue of the molten material, when filling the mold, exerting a force on the decorative film forcing the decorative film to abut intimately against the mold, hardening the molten material so as to form a hardened core, and forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

The novel features which are considered characteristic of the present invention are set forth in the appended claims. The invention itself, however, both as to its construction and its method of operation, together with additional objects and advantages thereof, will be best understood from the following description of the invention when read and understood in connection with the accompanying drawings.

### BRIEF DESCRIPTION OF THE DRAWINGS

The figures of the drawing are briefly described as follows:

FIGS. 1A-1D are a process flow chart for carrying out the method of the present invention.

### LIST OF REFERENCE NUMERALS UTILIZED IN THE DRAWINGS

10 method for making part 10 by injection molding and decorating visually-exposed face surface 12 and visually-exposed side surface 14 of part 10 in entireties during injection molding of part 10
12 visually-exposed face surface of part 10
14 visually-exposed side surface of part 10
16 part of mold 18
18 mold
20 cavity in part 16 of mold 18
22 face surface defining cavity 20 in part 16 of mold 18
24 side surface defining cavity 20 in part 16 of mold 18
26 parting line of mold 18 defining cavity 20 in part 16 of mold 18
28 decorative film
30 molten material
32 hardened core
34 face surface of hardened core 32
36 side surface of hardened core 32
38 edge of hardened core 32

### DETAILED DESCRIPTION OF THE INVENTION

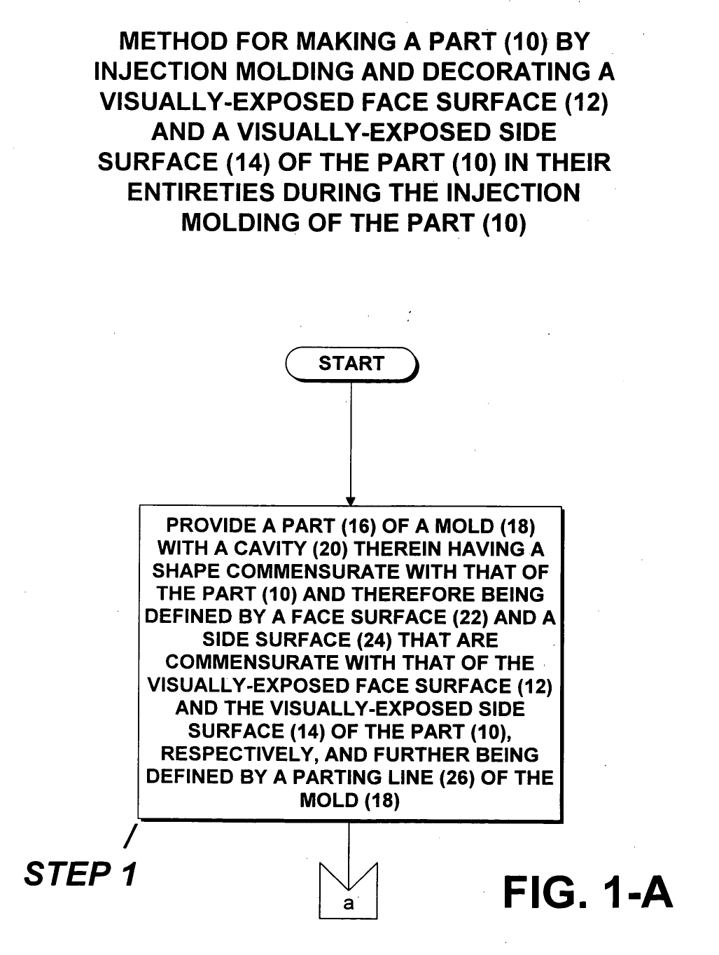

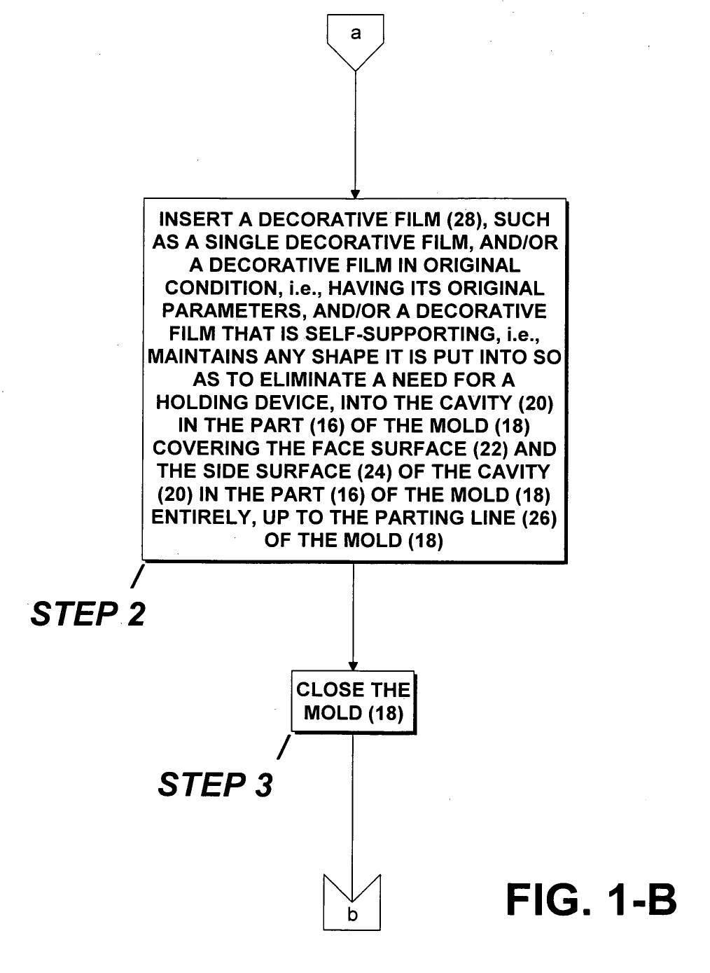

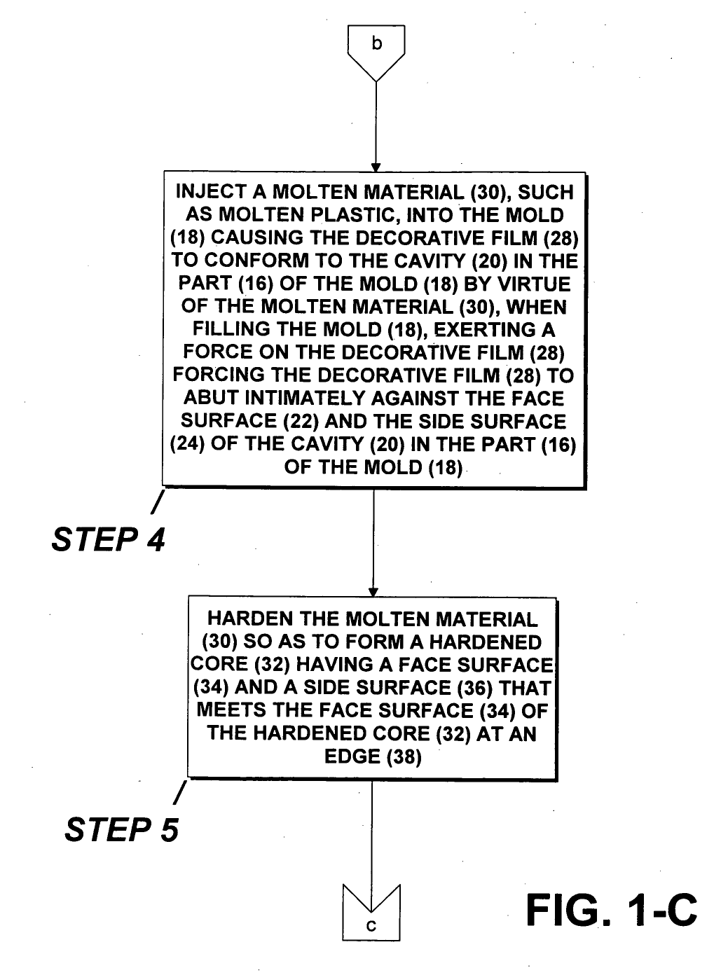

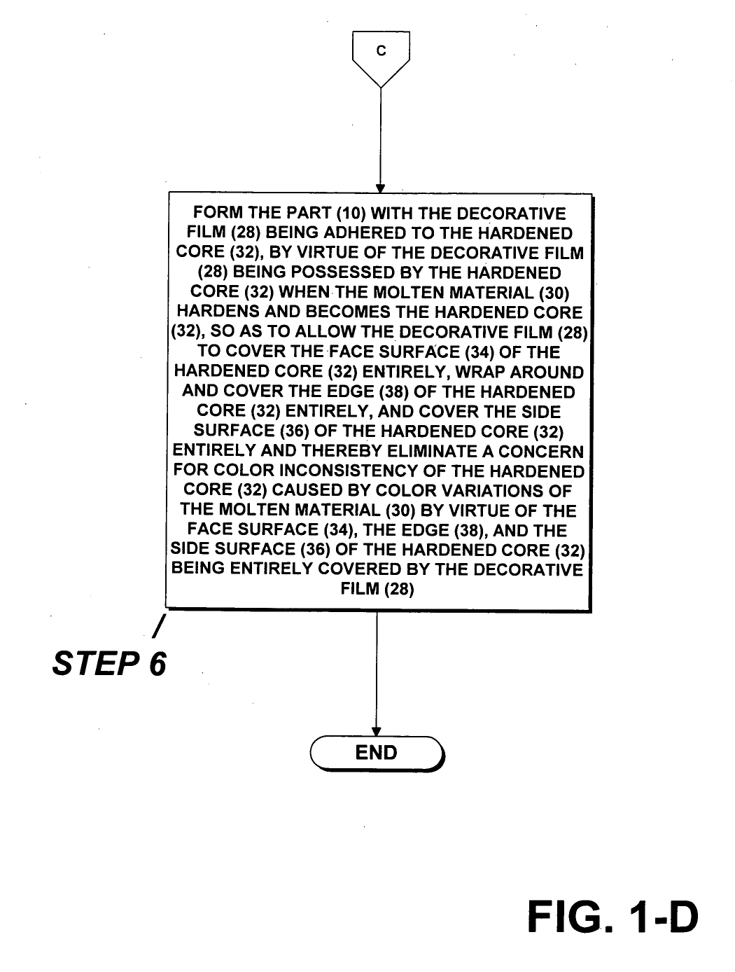

Referring now to FIGS. 1A-1D, which are a process flow chart for carrying out the method of the present invention, and in which like numerals indicate like parts, the method for making a part 10 by injection molding and decorating a visually-exposed face surface 12 and a visually-exposed side surface 14 of the part 10 in their entireties during the injection molding of the part 10 comprises the steps of:
STEP 1: Provide a part 16 of a mold 18 with a cavity 20 therein having a shape commensurate with that of the part 10 and therefore being defined by a face surface 22 and a side surface 24 that are commensurate with that of the visually-exposed face surface 12 and the visually-exposed side surface 14 of the part 10, respectively, and further being defined by a parting line 26 of the mold 18.
STEP 2: Insert a decorative film 28, such as a single decorative film, and/or a decorative film in original condition, i.e., having its original parameters, and/or a decorative film that is self-supporting, i.e., maintains any shape it is put into so as to eliminate a need for a holding device, into the cavity 20 in the part 16 of the mold 18 covering the face surface 22 and the side surface 24 of the cavity 20 in the part 16 of the mold 18 entirely, up to the parting line 26 of the mold 18.
STEP 3: Close the mold 18.
STEP 4: Inject a molten material 30, such as molten plastic, into the mold 18 causing the decorative film 28 to conform to the cavity 20 in the part 16 of the mold 18 by virtue of the molten material 30, when filling the mold 18, exerting a force on the decorative film 28 forcing the decorative film 28 to abut intimately against the face surface 22 and the side surface 24 of the cavity 20 in the part 16 of the mold 18.
STEP 5: Harden the molten material 30 so as to form a hardened core 32 having a face surface 34 and a side surface 36 that meets the face surface 34 of the hardened core 32 at an edge 38.
STEP 6: Form the part 10 with the decorative film 28 being adhered to the hardened core 32, by virtue of the decorative film 28 being possessed by the hardened core 32 when the molten material 30 hardens and becomes the hardened core 32, so as to allow the decorative film 28 to cover the face surface 34 of the hardened core 32 entirely, wrap around and cover the edge 38 of the hardened core 32 entirely, and cover the side surface 36 of the hardened core 32 entirely and thereby eliminate a concern for color inconsistency of the hardened core 32 caused by color variations of the molten material 30 by virtue of the face surface 34, the edge 38, and the side surface 36 of the hardened core 32 being entirely covered by the decorative film 28.

It will be understood that each of the elements described above, or two or more together, may also find a useful application in other types of constructions differing from the types described above.

While the invention has been illustrated and described as embodied in a method for making a part by injection molding and decorating visually-exposed face and side surfaces of the part in their entireties during the injection molding of the part, however, it is not limited to the details shown, since it will be understood that various omissions, modifications, substitutions, and changes in the forms and details of the device illustrated and its operation can be made by those skilled in the art without departing in any way from the spirit of the present invention.

Without further analysis the foregoing will so fully reveal the gist of the present invention that others can by applying current knowledge readily adapt it for various applications without omitting features that from the standpoint of prior art fairly constitute characteristics of the generic or specific aspects of the invention.

1. A method for making a part by injection molding and decorating a visually-exposed face surface and a visually-exposed side surface of the part in their entireties during the injection molding of the part, said method comprising the steps of:
a) providing a mold;
b) inserting a decorative film into the mold;
c) closing the mold;
d) injecting a molten material into the mold causing the decorative film to conform to the mold by virtue of the molten material, when filling the mold, exerting a force on the decorative film forcing the decorative film to abut intimately against the mold;
e) hardening the molten material so as to form a hardened core; and
f) forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

2. The method as defined in claim 1, wherein said providing step includes providing a part of a mold with a cavity therein.

3. The method as a defined in claim 2, wherein said providing step includes providing a part of a mold with a cavity therein having a shape commensurate with that of the part and therefore being defined by a face surface and a side surface that are commensurate with that of the visually-exposed face surface and the visually-exposed side surface of the part, respectively, and further being defined by a parting line of the mold.

4. The method as defined in claim 3, wherein said inserting step includes inserting a decorative film into the cavity in the part of the mold covering the top surface and the side surface of the cavity in the part of the mold entirely, up to the parting line of the mold.

5. The method as defined in claim 1, wherein said injecting step includes injecting molten plastic into the mold.

6. The method as defined in claim 3, wherein said injecting step includes injecting a molten material into the mold causing the decorative film to conform to the cavity in the part of the mold by virtue of the molten material, when filling the mold, exerting a force on the decorative film forcing the decorative film to abut intimately against the face surface and the side surface of the cavity in the part of the mold.

7. The method as defined in claim 1, wherein said hardening step includes hardening the molten material so as to form a hardened core having a face surface and a side surface that meets the face surface of the hardened core at an edge.

8. The method as defined in claim 7, wherein said forming step includes forming the part with the decorative film being adhered to the hardened core, by virtue of the decorative film being possessed by the hardened core when the molten material hardens and becomes the hardened core, so as to allow the decorative film to cover the face surface of the hardened core entirely, wrap around and cover the edge of the hardened core entirely, and cover the side surface of the hardened core entirely and thereby eliminate a concern for color inconsistency of the hardened core caused by color variations of the molten material by virtue of the face surface, the edge, and the side surface of the hardened core being entirely covered by the decorative film.

9. The method as defined in claim 1, wherein said inserting step includes inserting a single decorative film into the mold.

10. The method as defined in claim 1, wherein said inserting step includes inserting a decorative film in original condition into the mold.

11. The method as defined in claim 1, wherein said inserting step includes inserting a decorative film that is self-supporting so as to eliminate a need for a holding device into the mold.
